(19) United States
(12) Patent Application Publication
(10) Pub. No.: US 2021/0393033 A1
(43) Pub. Date: Dec. 23, 2021

(54) TABLE SHELF AND EASEL SYSTEM

(71) Applicant: Kazuyoshi MORITA, Saitama (JP)

(72) Inventors: Kazuyoshi MORITA, Saitama (JP); Masayoshi OKAYASU, Saitama (JP)

(73) Assignee: Kazuyoshi MORITA, Saitama (JP)

(21) Appl. No.: 17/293,221

(22) PCT Filed: Nov. 11, 2019
(86) PCT No.: PCT/JP2019/044054

§ 371 Date: Aug. 11, 2021

(30) Foreign Application Priority Data
Nov. 14, 2018 (JP) 2018-213686

(51) Int. Cl. A47B 97/04; A47B 96/02; B44D 3/00

(52) U.S. Cl. CPC A47B 97/04; B44D 3/00; A47B 96/02

(57) ABSTRACT

A table shelf is provided which can be firmly attached in harmony with the shape and diameter of the legs of various tripods. A table shelf 3 attached to the tripod 80. Shelves 3, plate-shaped board part 30 and the board part 30 the beam part is attached to the side edge vicinity of 31 and the beam part 31 a pair of right and left attached to the engaging arm parts 32, 32 a, tripod 80 It is provided with engaging arm parts 32, 32 extending from the outside to the inside so as to hold the two legs 81, 81. The engaging arm part 32 is adapted to extend diagonally with respect to the beam part 31 so that the gap 34 formed between the engaging arm part 32 and the beam part 31 is narrowed on the outside and widened on the inside.

### TECHNICAL FIELD

The present invention relates to a table shelf that can be attached to various commercially available tripods.

Traditionally, camera tripods have been known to be compact and highly portable. In addition, the camera stand where the camera is installed can be freely changed in angle, orientation, height, and rotation. Therefore, when creating a painting, if you fix the canvas to a commercially available camera tripod, you can freely change the orientation horizontally, vertically, or diagonally as needed, and the canvas is stable. It is convenient because it can be used as an easel that can fix the camera.

That is, the canvas fixed to the tripod for the camera is functionally superior to the standard size painting easel of a general shape. Similarly, if a table shelf is fixed to a tripod for a camera, tools and materials that tend to be scattered on the floor can be held in the space under the canvas (see, for example, Patent Document 1) .

### BACKGROUND ART

[Patent Document 1] Japanese Laid-open Patent Publication No. 2010-214936

### DISCLOSURE OF INVENTION

### Problem to be Solved by Invention

However, conventional table shelves as described in Patent Document 1 have been developed exclusively for tripods of a specific manufacturer. Therefore, there is a problem that the tripod cannot be firmly attached because it does not match the tripod of another manufacturer having a different shape and diameter of the leg.

Therefore, an object of the present invention is to provide a table shelf that can be firmly attached in harmony with the shape and diameter of the legs of various tripods, and an easel system provided with the table shelf.

### Means to Solve the Problem

In order to achieve the above object, the table shelf of the present invention is a table shelf attached to a tripod and is attached to a flat plate-shaped board part, a beam part attached near the side edge of the board part, and the beam part. It is a pair of left and right engaging arm parts to be attached, and includes an engaging arm part extending from the outside to the inside so as to hold the two legs of the tripod.

Further, it is preferable that the engaging arm part is adapted to extend diagonally with respect to the beam part so that the gap formed between the engaging arm part and the beam part is narrowed on the outside and widened on the inside.

Further, it is preferable that the engaging arm part is configured to be slidable with respect to the beam part.

Further, the easel system of the present invention is composed including a tripod, one of the table shelves described above attached to hold the two legs of the tripod, and an easel attached to the camera stand of the tripod.

Further, the easel is preferably composed of a major axis rod part attached to the camera stand of the tripod and a pair of board receiving parts configured to be slidable along the major axis rod part that can hold the canvas from above and below.

### Advantage of the Invention

As described above, the table shelf of the present invention is a table shelf attached to a tripod, and has a flat plate-shaped board part, a beam part attached near the side edge of the board part, and a pair of left and right engaging arm part attached to the beam part. It is an engaging arm part and includes an engaging arm part that extends from the outside to the inside so as to hold the two legs of the tripod. With such a configuration, it becomes a table shelf that can be firmly attached in harmony with the shape and diameter of the legs of various tripods.

Further, the engaging arm part, a gap formed between the beam part is narrowed at the outer, and so as to be wider on the inside, is to extend diagonally to the beam part for which, variety It will be a table shelf that can be firmly and firmly attached in harmony with the shape and diameter of the legs of a tripod.

Furthermore, since the engaging arm part is configured to be slidable with respect to the beam part, it becomes a table shelf that can be stably attached in harmony with the shape and diameter of the leg part of a wider range of tripods. In addition, by adjusting the distance between the pair of engaging arm parts, the height position for mounting the table shelf can be set as desired.

Further, the easel system of the present invention includes a tripod, one of the above-mentioned table shelves mounted so as to hold the two legs of the tripod, and an easel mounted on a camera stand of the tripod. With such a configuration, the canvas can be fixed stably, it can be adjusted to any position and angle even during production, and at the same time, it becomes possible to secure a space for a shelf to put tool materials at a desired height position at hand.

In addition, the easel is a major axis rod part that is attached to the camera stand of a tripod and a pair of board receiving parts that can be slid along the major axis rod part so that the canvas can be held from above and below. It is preferable that the board receiving part is composed of a pair of board receiving parts. With such a configuration, the canvas can be firmly sandwiched and fixed by a simple structure.

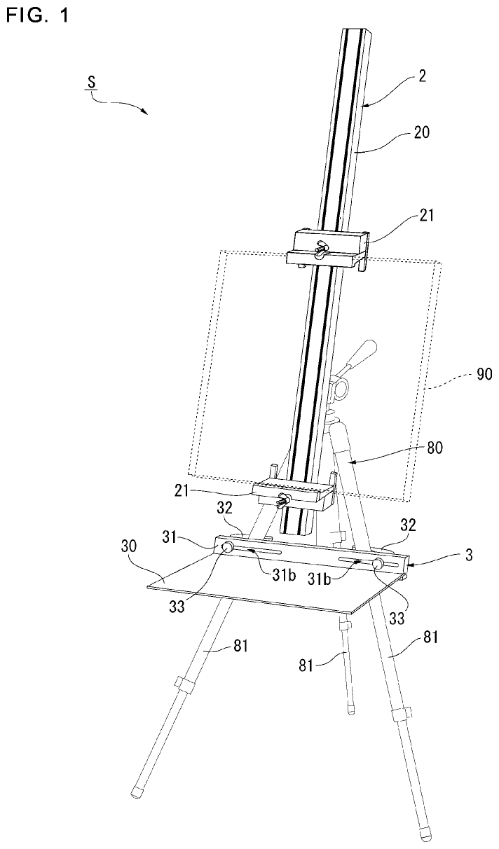

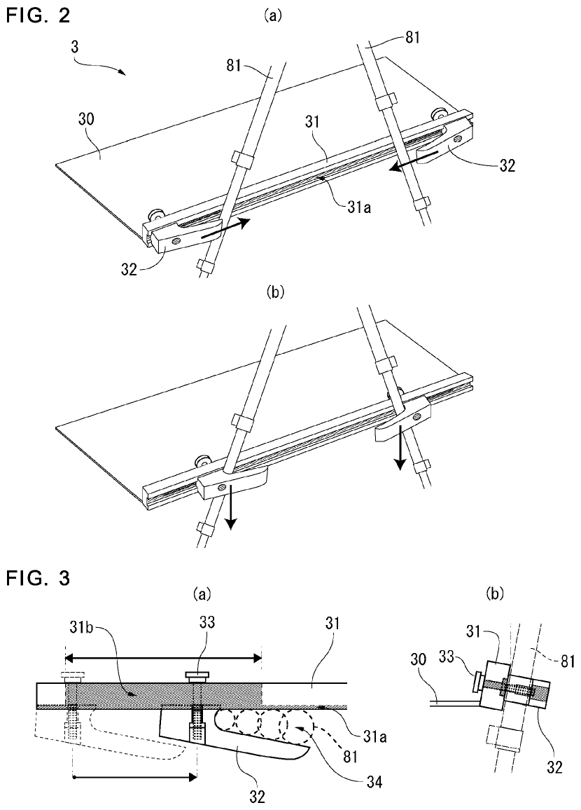

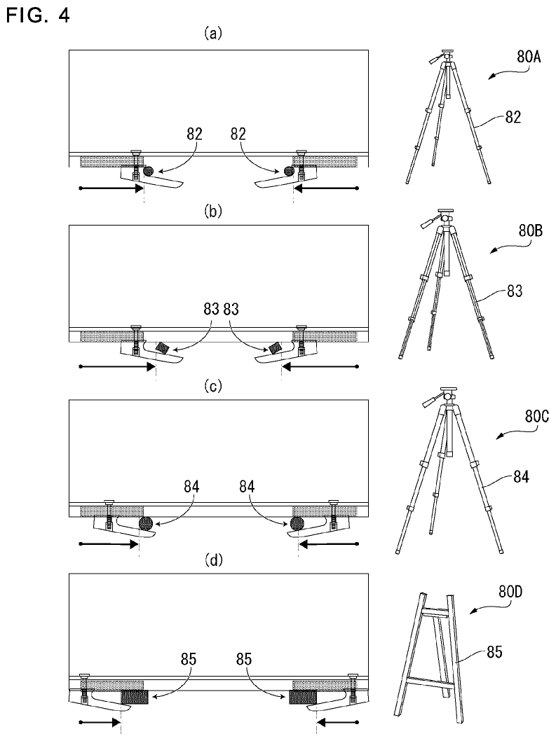

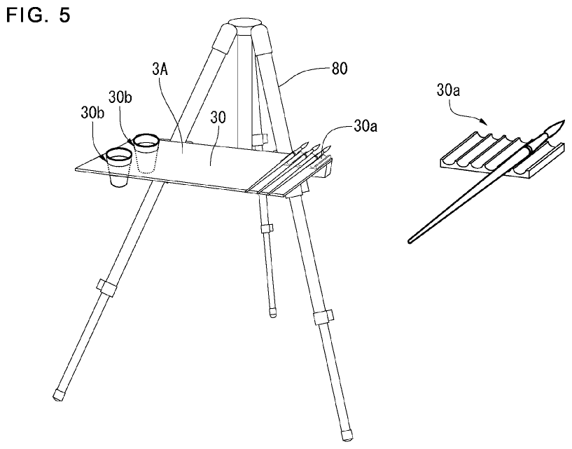

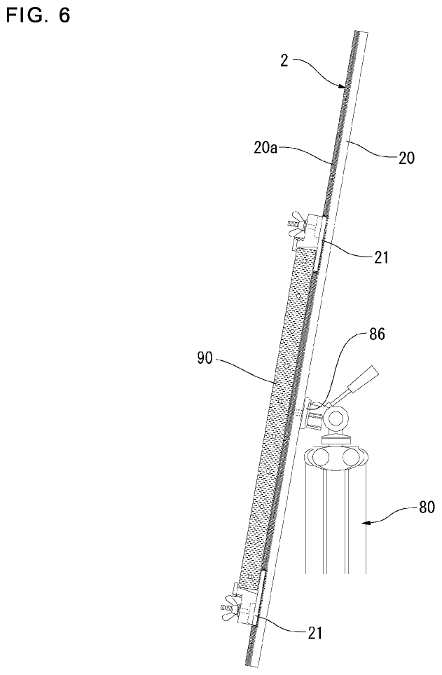

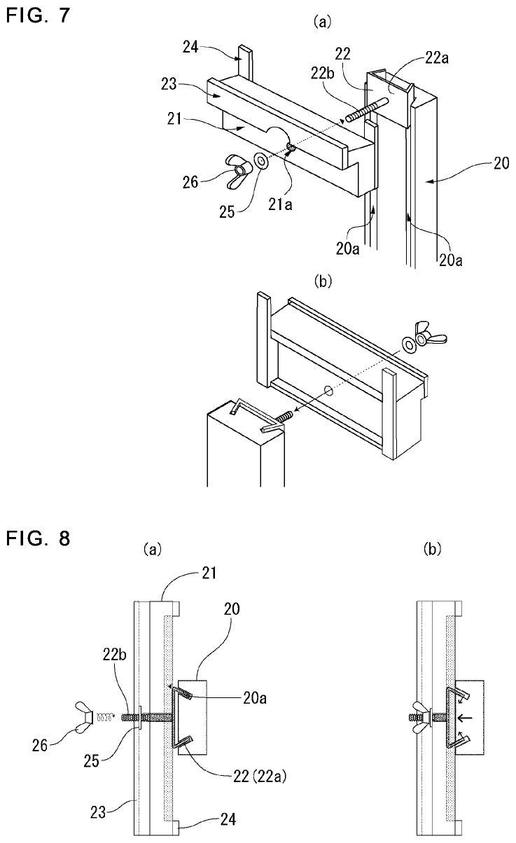

### BRIEF DESCRIPTION OF DRAWINGS

[FIG. 1] is a perspective drawing of an easel system of an embodiment.

[FIG. 2] is a perspective drawing illustrating the configuration of a table shelf. (A) is a state before sliding the engaging arm part, and (b) is a state after sliding.

[FIG. 3] is explanatory drawing explaining the operation of the engaging arm part. (A) is a plan view, and (b) is a side view.

[FIG. 4] is an explanatory drawing illustrating the operation of a table shelf. (A) is for a small tripod with a circular cross section, (b) is for a small tripod with a quadrangular cross section, (c) is for a large tripod with a circular cross section, and (d) is for a large easel tripod with a quadrangular cross section. This is the case when a table shelf is applied.

[FIG. 5] is a perspective drawing of a modified example table shelf.

[FIG. 6] is a side view of the easel.

[FIG. 7] is a perspective drawing of a board receiving part of the easel. (A) is a view from the front direction, and (b) is a view from the back direction.

[FIG. 8] is sectional drawing explaining the operation of the board receiving part. (A) is a state in which the position is not fixed, and (b) is a state in which the position is fixed.

### BEST MODE FOR CARRYING OUT THE INVENTION

Hereinafter, embodiments of the present invention will be described with reference to the drawings. The following examples are examples, and the technical scope of the present invention is not limited to the scope described in the following examples.

### EXAMPLE

### (Easel System Configuration)

First, the overall configuration of the easel system S including the table shelf 3 of the present invention will be described with reference to FIG. 1. The easel system S of the present embodiment is composed of a tripod 80, a table shelf 3 attached so as to hold the two legs 81 and 81 of the tripod 80, and an easel 2 attached to the camera stand 86 of the tripod 80.

### (Structure of the Tripod Formed)

The tripod 80 is a commercially available tripod 80 for a camera (or a video camera) for still image shooting or video shooting, and is a camera stand (head, cloud stand) having a screw on which the camera (or video camera) is installed. It includes 86, three legs 81, 81, 81 extending diagonally downward from the camera base 86, and a center pole 87 for height adjustment extending through the camera base 86.

Each leg 81 is formed, for example, in a three-stage nested shape (telesco shape), and its length can be freely adjusted. The three legs 81, 81, 81 extend downward so as to be widely spaced so as to maintain the same inclination angle (opening degree). The camera base 86 is capable of undulating rotation (XZ direction) and horizontal rotation (XY direction), for example. The camera base 86 may be capable of rotating left and right (YZ direction).

### (Composition of Table Shelf)

The table shelf 3 includes a flat plate-shaped board part 30, a beam part 31 attached near the side edge of the board part 30, and a pair of left and right engaging arm parts 32, 32, which are attached to the beam part 31 and are provided with engaging arm parts 32, 32 extending from the outside to the inside so as to hold the two legs 81, 81 of a tripod 80.

The board part 30 is formed of a wooden quadrangular flat plate and forms a main part of the function of the table shelf 3 as a table. That is, a pallet or a brush (not shown) is placed on the board part 30. In this embodiment, the board part 30 is fixed to the lower side of the beam part 31, but as shown in FIG. 5 described later, the board part 30 may be fixed to the upper side of the beam part 31. The board part 30 is arranged on the front side (outside of the tripod 80) of the two leg parts 81, 81 of the tripod 80, and is in a position that is easy for the creator to use.

The beam part 31 is formed of a wooden rod member (square lumber) and has a function of reinforcing the rigidity of the board part 30 and holding the pair of engaging arm parts 32, 32 such that the pair of engaging arm parts 32, 32 is slidable. As shown in FIGS. 1 to 3, the beam part 31 is formed with elongated hole parts 31b along the length direction on the left and right sides on the front side close to the board part 30, and the beam part 31 is formed with a groove 31a on the back side along the length direction thereof.

In addition, as shown in FIG. 3B, the beam part 31 is attached so as to be inclined with respect to the board part 30. That is, when the leg part 81 of the tripod 80 is inclined, the board part 30 is not horizontal when the beam part 31 and the board part 30 are vertically attached. Therefore, the board part 30 is made horizontal by inclining the beam part 31 and the board part 30 so as to cancel the inclination in accordance with the inclination of the leg part 81 of the commercially available tripod 80.

The engaging arm part 32 is fixed to the left and right elongated hole parts 31b of the beam part 31 by bolts 33. Further, since the base end part of the engaging arm part 32 is fitted into the groove part 31a on the back surface side, as shown in FIG. 3A, the engaging arm part 32 is configured to be slidable in the length direction of the beam part 31.

The engaging arm parts 32, 32 are formed of a piece of wood, and extend from the outside to the inside so as to hold the two legs 81, 81 of the tripod 80. That is, the engaging arm part 32 has a base end part (base) located on the outside thereof and a cantilever-protruding tip part located on the inside thereof.

Then, the engaging arm part 32 is formed in the beam part 31 so that the gap 34 formed between the engaging arm part 32 and the beam part 31 is narrowed on the outside side of the base end part side and widened on the inside side on the tip end part side. On the other hand, it is formed so as to extend diagonally. The innermost part of the gap 34 is preferably formed in an arc shape, but when the width of the innermost gap 34 is formed extremely narrow, it is not necessarily formed in an arc shape.

Further, the width of the gap 34 is such that the width of the most advanced position (entrance position) is set to fit the leg part 81 having the maximum diameter of a commercially available tripod (80C, 80D), and the width of the innermost position is a commercially available tripod. It is set to fit the leg part 81 having the smallest diameter (80A, 80B). Hereinafter, this point will be described with reference to specific examples shown in FIGS. 4A to 4D.

First, in the case of the small tripod 80A having a circular cross section shown in FIG. 4A, the leg part 82 is fixed in contact with the innermost part of the gap 34. Next, in the case of the small tripod 80B having a quadrangular cross section shown in FIG. 4B, the leg part 83 is fixed diagonally at an intermediate position of the gap 34.

Further, in the case of the large tripod 80C having a circular cross section shown in FIG. 4C, the leg part 84 is fixed in contact with the position near the entrance of the gap 34. Next, in the case of the large-sized easel tripod 80D for painting with a quadrangular cross section shown in FIG. 4(d), the leg 85 is fixed at a position near the entrance of the gap 34 with one side and diagonal in contact with each other.

In this way, the legs (82 to 85) having a wide range of diameters and shapes as described above are fitted into the gap 34 formed between the engaging arm part 32 and the beam part 31. Therefore, the wobbling of the table shelf 3 can be suppressed, and the table shelf 3 can be firmly and stably fixed.

As in the table shelf 3A of another form shown in FIG. 5, the board part 30 has a brush holder 30a in which a plurality of corrugated irregularities are formed, and a circular hole provided in the vicinity of the left or right side edge. It is also preferable that the cup holders 30b and 30b are added.

### (Action of Table Shelf)

The above-mentioned table shelf 3 has the following functions.
(1) It can be used by jointing with a commonly used small to medium-sized tripod and can be stably fixed to most tripods 80 with three legs regardless of the manufacturer, type, and shape and size of the tripod.
(2) It can be quickly fixed in the center (in front of the body) with one touch without troublesome movements.
(3) By adjusting the distance between the engaging arm parts 32 and 32, the height of fixing to the tripod 80 for the camera can be freely changed.
(4) Self-supporting target popular types that are commercially available quasi easel (camera tripod without generally easel tripod) can be stably fixed.
(5) When installing options such as a cup holder 30b (perforated shelf) and a brush holder 30a (shelf with a brush holder) that support the production of watercolors and oils, adjustment and fixing are possible by putting the board part 30 to the right or left from the center.
(6) The point that the beam part 31 of the table shelf 3 is inclined (angled) so as to follow the angle of the leg part 81 of the tripod 80, and the fitting arm part 32 that slides and tightens from the left and right are “gap 34 toward the back”. Since it has a structure in which the width of the table is narrowed, a downward load is applied to the table shelf 3 by placing a tool after sliding and tightening, so that the table shelf 3 becomes more stable and fixed.

### (Easel Configuration)

As shown in FIGS. 1 and 6, the easel 2 is attached to the camera base 86 of the tripod 80 and has a function of holding the canvas 90 in a desired orientation and position. Specifically, the easel 2 is a major axis rod part 20 attached to the camera base 86 of the tripod 80, and a pair of board receiving parts 21 and 21 configured to be slidable along the major axis rod part 20. The canvas 90 is composed of a pair of board receiving parts 21 and 21 that can hold the canvas 90 from above and below.

The major axis rod part 20 is formed of a wooden rod member (square member), and a pair of groove parts 20a and 20a extending along the length direction are formed on the left and right sides of the front side. As shown in FIGS. 7 and 8, the groove part 20a is formed so as to incline from the outside to the inside in the depth direction and forms an elongated space (gap) having a C-shaped cross section. Further, on the back surface side of the major axis rod part 20, a female screw hole 20b screwed into the male screw 86a of the camera base 86 of the tripod 80 is embedded near the center in the length direction. It is preferable that a plurality of female screw holes 20b are arranged at different positions in the length direction.

The board receiving part 21 is formed of a wooden L-shaped cross-section rod member (square member) and includes a front stopper 23 and back stoppers 24, 24 for sandwiching the canvas 90 from the front and back. Further, a hole 21a is formed through the center of the board receiving part 21. Then, the screw part 22b of the metal fitting 22 described later is inserted into the hole 21a, and the wing nut 26 is screwed through the washer 25. The board receiving part 21 is formed of a wooden L-shaped cross-section rod member (square member) and includes a front stopper 23 and back s major axis toppers 24, 24 for sandwiching the canvas 90 from the front and back. Further, a hole 21a is formed through the center of the board receiving part 21. Then, the screw part 22b of the metal engaging 22 described later is inserted into the hole 21a, and the wing nut 26 is screwed through the washer 25.

Then, the C-shaped plate part 22a of the metal fitting 22 is slidably fitted into the groove part 20a of the major axis rod part 20, and the screw part 22b of the metal fitting 22 is penetrated and fixed in the hole 21a of the board receiving part 21. As a result, the major axis rod part 20 and the board receiving part 21 are fixed so as to be attracted to each other. That is, the metal fitting 22 is integrally provided with a C-shaped plate part 22a that is slightly smaller than the groove part 20a of the major axis rod part 20 and a screw part 22b projecting from the center of the C-shaped plate part 22a.

Therefore, as shown in FIG. 8A, when the wing nut 26 is loosened, the board receiving part 21 is separated from the major axis rod part 20, and the C-shaped plate part 22a of the metal engaging 22 is the major axis rod part 20. It is possible to freely slide and move in the groove part 20a of the. On the other hand, as shown in FIG. 8B, when the wing nut 26 is tightened, the board receiving part 21 is pressed against the major axis rod part 20, and the C-shaped plate part 22a of the metal engaging 22 is the major axis rod part 20. It is pressed against the board receiving part 21 side in the groove part 20a of the above.

As a result, when the wing nut 26 is tightened, the board receiving part 21 and the major axis rod part 20 exert a drag force on each other, and a large frictional force acts between them to restrain the slide movement. Therefore, as shown in FIG. 1, by restraining the canvas 90 by the upper and lower board receiving parts 21, the canvas 90 can be firmly fixed at an arbitrary position along the major axis rod part 20.

For example, either the lower board receiving part (21) or the upper board receiving part (21) may be fixed to the major axis rod part 20 so as not to move. Further, two canvases 90 can be fixed by using four board receiving part 21, or a large number of canvases 90 can be fixed by using a larger number of board receiving part 21.

### (Easel Action)

Described above easel 2 is generally has a function as described below.
(1) It can be used in combination with a camera tripod 80 and can be stably fixed to all sizes of canvas, panels, and sketchbooks that are commonly drawn outdoors and indoors. In the present invention, the smallest canvas size 0 (180×140 (mm)) to the medium size 30 (910×727 (mm), which can be said to be a large size in the field) is supported.
(2) The simple structure improved portability and maneuverability.
(3) Since two canvases can be installed on the top and bottom at the same time, it is possible to produce two canvases at the same time or to copy while looking at a sample work with one easel.
(4) By fixing the receiving unit 21 with a simple structure in which the bracket 22 slides the groove 20a and the groove 20a inclined to the main shaft rod portion 20 of the easel 2, everything from the minimum canvas No. 0 size (180×140 (mm)) to the medium no. 30 (910×727 (mm)) size can be stably fixed.
(5) By adding the board receiving part 21, two or more canvases can be fixed at the same time.
(6) By cutting the major axis rod part 20 (wood) of the easel 2 at the request of the user, the length can be easily adjusted to suit one's wishes.
(7) By attaching three nuts for a camera tripod to the major axis rod 20 of the easel 2 in advance at a distance of about one-third, one long major axis rod part 20 can be cut and two short major axis rod parts 20 can be taken. There are two easels 2 for small works and medium works.

### (Overall Action)

As described above, by using the easel system S of this embodiment, the canvas of the medium-sized work size required by art lovers can be held, and the number of parts is reduced and the weight is reduced due to the simple structure, so that a small turn can be achieved. It is an easel system S that is effective and has excellent portability and storage. Therefore, the canvas 90 and tools can be installed smoothly and easily until the work is started. Therefore, the easier it is to prepare, clean up, and draw, the more fun it is to draw.

Although the embodiments of the present invention have been described in detail with reference to the drawings, the specific configuration is not limited to this embodiment, and design modifications that do not deviate from the gist of the present invention are included in the present invention.

### DESCRIPTION OF REFERENCE SYMBOLS

S easel system
2 easel
20 major axis rod
21 board receiving part
3 table shelves
30 board part
31 beam
32 engaging arm
80 tripod
81˜83 leg
90 canvas

1. A table shelf capable of attaching to a tripod, the table shelf comprising:
a board part in a form of a flat plate;
a beam part attached to the board part at a position adjacent to a side edge of the board part; and
a pair of left and right engaging arm parts extending from an outside to an inside such that the engaging arm parts hold two legs of the tripod, wherein the engaging arm parts are configured to extend diagonally with respect to the beam part such that gaps formed with respect to the beam part narrow at the outside thereof and widen at the inside thereof.

2. (canceled)

3. The table shelf as claimed in claim 1, wherein the engaging arm parts are configured to be slidable with respect to the beam part.

4. An easel system, comprising:
a tripod;
a table shelf comprising:
a board part in a form of a flat plate;
a beam part attached to the board part at a position adjacent to a side edge of the board part; and
a pair of left and right engaging arm parts extending from an outside to an inside such that the engaging arm parts hold two legs of the tripod, wherein the engaging arm parts are configured to extend diagonally with respect to the beam part such that gaps formed with respect to the beam part narrow at the outside thereof and widen at the inside thereof; and
an easel capable of being attached to a camera stand of the tripod.

5. The easel system as claimed in claim 4, the easel comprising:
a major axis rod part attached to the tripod of the camera stand; and
a pair of board receiving parts slidable along a major axis rod part, the board receiving parts being configured to hold a canvas from above and below.

6. The easel system as claimed in claim 4, wherein the engaging arm parts are configured to be slidable with respect to the beam part.
